(19) United States
(12) Patent Application Publication
(10) Pub. No.: US 2026/0126079 A1
(43) Pub. Date: May 7, 2026

(54) SLIDING MEMBER AND MANUFACTURING METHOD OF SLIDING MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Nobuyuki OTAKE, Nisshin-shi (JP)

(21) Appl. No.: 19/360,647

(22) Filed: Oct. 16, 2025

(30) Foreign Application Priority Data
Nov. 6, 2024 (JP) 2024-194492

(51) Int. Cl. F16C 33/10

(52) U.S. Cl. CPC F16C 33/1095

(57) ABSTRACT

A sliding member includes a base member and a solid lubricant film disposed to cover the base member. The solid lubricant film is composed of molybdenum disulfide in which a sulfur-to-molybdenum content ratio is 1.33 or less. The molybdenum disulfide constituting the solid lubricant film may contain 11 atomic percent or more of carbon.

### CROSS REFERENCE TO RELATED APPLICATION

The present application claims the benefit of priority from Japanese Patent Application No. 2024-194492 filed on Nov. 6, 2024. The entire disclosure of the above application is incorporated herein by reference.

### TECHNICAL FIELD

The present disclosure relates to a sliding member and a manufacturing method of a sliding member.

### BACKGROUND

Sliding members made of molybdenum disulfide, which possesses self-lubricating properties, have been conventionally known in various forms.

### SUMMARY

A sliding member according to an aspect of the present disclosure includes a base member and a solid lubricant film disposed to cover the base member. The solid lubricant film may be composed of molybdenum disulfide in which a sulfur-to-molybdenum content ratio is 1.33 or less.

### BRIEF DESCRIPTION OF DRAWINGS

Objects, features and advantages of the present disclosure will become apparent from the following detailed description made with reference to the accompanying drawings. In the drawings:

FIG. 1 is a cross-sectional view showing a schematic configuration of a sliding member according to an embodiment of the present disclosure;

FIG. 2 is a cross-sectional transmission electron microscope (TEM) image of the vicinity of an interface between an aluminum oxide coating film and a solid lubricant film in the configuration shown in FIG. 1;

FIG. 3 is a cross-sectional TEM image of the vicinity of an interface between an aluminum oxide coating film and a solid lubricant film in a comparative example;

FIG. 4 is a graph showing a change in the coefficient of friction over the sliding duration in the comparative example;

FIG. 5 is a graph showing a sliding cross-sectional profile in the comparative example;

FIG. 6 is a graph showing a change in the coefficient of friction over the sliding duration in Example;

FIG. 7 is a graph showing a sliding cross-sectional profile in an example;

FIG. 8 is a graph comparing X-ray diffraction intensity patterns of the example and another comparative example;

FIG. 9 is a graph showing the relationship between the sulfur-to-molybdenum content ratio (S/Mo) and the carbon concentration;

FIG. 10 is a graph showing the relationship between the adhesion strength and the carbon concentration in the solid lubricant film; and

FIG. 11 is a graph showing the dependence of carbon concentration in the solid lubricant film on the film formation temperature.

### DETAILED DESCRIPTION

A sliding member according to a related art includes a base member and a sliding layer formed on at least a sliding surface of the base member. The sliding layer contains molybdenum disulfide. The sliding layer consists of a first sliding layer formed on the base member and a second sliding layer laminated on the first sliding layer. The first sliding layer contains 10 atomic percent or less of a metal element and/or a compound of a metal element, when the total is set to 100 atomic percent. The metal element is at least one selected from a group consisting of Ti, Cr, W, Zr, and V. The second sliding layer does not contain such metal elements and/or compounds of metal elements.

When the first sliding layer contains the metal elements or the compounds of metal elements, a decrease in the strength of the first sliding layer and delamination from the base member are suppressed. Since the second sliding layer does not contain metal elements or compounds of metal elements, the second sliding layer is a soft layer with lower hardness compared to the first sliding layer. Therefore, the second sliding layer exhibits high conformability to the mating material during sliding.

Molybdenum disulfide has a layered crystal structure along the (001) planes, and delamination readily occurs along these planes. Therefore, for example, when the (001) planes are oriented perpendicular to the load direction, delamination occurs, whereas if the (001) planes are oriented parallel to the load direction, delamination can be suppressed. However, in general, the (001) planes in the sliding layer are oriented in random directions, making it difficult to achieve complete alignment in a single direction and, consequently, to sufficiently suppress delamination. Furthermore, when the load direction and the sliding direction are not the same, frictional force is applied in the sliding direction, so even if delamination is suppressed in the load direction, delamination may occur in the sliding direction.

A sliding member according to a first aspect of the present disclosure includes a base member and a solid lubricant film disposed to cover the base member. The solid lubricant film is composed of molybdenum disulfide in which a sulfur-to-molybdenum content ratio is 1.33 or less.

A manufacturing method according to a second aspect of the present disclosure is a manufacturing method a sliding member that includes a base member and a solid lubricant film disposed to cover the base member, and the solid lubricant film is composed of molybdenum disulfide in which a sulfur-to-molybdenum content ratio is 1.33 or less. The manufacturing method includes forming the solid lubricant film by an atomic layer deposition method using an organic material having a tertiary-butyl group as a sulfur-containing raw material.

### Embodiment

Hereinafter, an embodiment of the present disclosure will be described with reference to the accompanying drawings. It should be noted that the following embodiment, its variations, and the accompanying drawings are simplified or schematic representations provided to concisely explain the content of the present disclosure and do not limit the scope of the present disclosure in any way. Therefore, it is understood that the descriptions in the drawings may not necessarily correspond exactly to the specific device configurations that are actually manufactured and sold. In other words, unless explicitly limited by the applicants during the prosecution of the present application, the present disclosure should not be construed as being limited by the descriptions in the drawings or the configurations, functions, or operations described hereinafter.

### Configuration

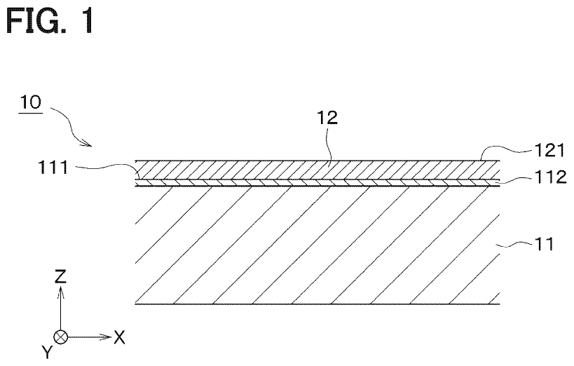

Hereinafter, a schematic configuration of a sliding member 10 according to an embodiment of the present disclosure will be described with reference to FIG. 1. As shown in FIG. 1, the sliding member 10 includes a base member 11 and a solid lubricant film 12 disposed so as to cover the base member 11.

To simplify illustration and description, a right-handed XYZ coordinate system as shown in FIG. 1 is adopted. Here, a Z-axis direction is referred to as a “height direction”, and any direction within the XY plane is referred to as an “in-plane direction”. In the present embodiment, the sliding member 10 has a structure in which the base member 11 and the solid lubricant film 12 are laminated in the height direction.

The base member 11 is formed from a metal material such as a steel material, for example, bearing steel such as SUJ2. In the present embodiment, the base member 11 has a plate-like, that is, disk-like shape having a thickness in the height direction. Then, the solid lubricant film 12 is formed on a coated surface 111, which is one surface of the base member 11 in the thickness direction. The coated surface 111 is formed as a flat surface extending in the in-plane direction.

In the present embodiment, the base member 11 has an aluminum oxide coating film 112 on the coated surface 111, which is the outermost surface of the base member 11. That is, the coated surface 111 is provided as the outer surface of the aluminum oxide coating film 112, which is the outermost layer of the base member 11. The aluminum oxide coating film 112 is formed as a thin film having a thickness in the height direction. The solid lubricant film 12 is formed on the aluminum oxide coating film 112.

The solid lubricant film 12 is a self-lubricating film whose main component is molybdenum disulfide. The solid lubricant film 12 is formed with a uniform thickness in the height direction. That is, a sliding surface 121 of the sliding member 10 is provided as the surface of the solid lubricant film 12.

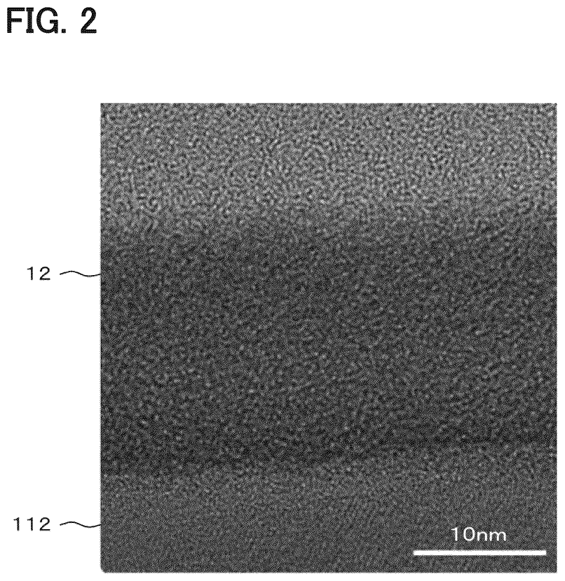

Here, in the present embodiment, the solid lubricant film 12 is composed of molybdenum disulfide in which the content ratio of sulfur to molybdenum (that is, S/Mo) is 1.33 or less. Specifically, the solid lubricant film 12 contains 11 atomic percent or more of carbon. As is clear from the cross-sectional TEM photograph shown in FIG. 2, the solid lubricant film 12 has an amorphous structure. The S/Mo content ratio may be set, for example, within a range of 1.03 or more and 1.33 or less. The carbon content mat be set, for example, within a range of 11 atomic percent or more and 12 atomic percent or less.

### Advantageous Effects

Hereinafter, the wear resistance performance exhibited by the sliding member 10 according to the present embodiment will be described with reference to examples and comparative examples.

In environments where lubricating oil cannot be used, such as in vacuum, in hydrogen atmospheres, or in corrosive atmospheres, sliding elements made of molybdenum disulfide with self-lubricating properties are employed. Here, as is well known, molybdenum disulfide (that is, MoS₂) has a hexagonal crystal system in its crystalline state and exhibits a layered structure along the (001) planes. Due to the weak van der Waals bonds between layers, the layers are prone to delamination, resulting in the issue that wear due to sliding is likely to occur.

In this regard, for example, when the (001) planes are oriented perpendicular to the load direction, delamination occurs, whereas if the (001) planes are oriented parallel to the load direction, delamination can be suppressed. Therefore, measures to improve wear resistance by controlling the orientation of the planes can be considered.

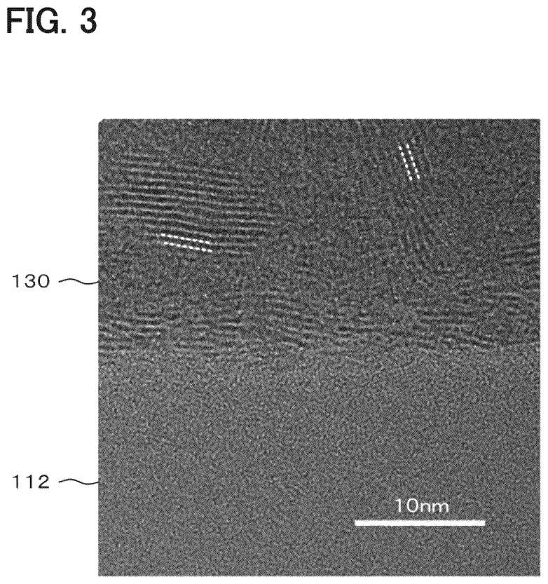

FIG. 3 is a cross-sectional TEM photograph showing a comparative coating film 130 that is a conventional MoS₂ film formed by a well-known film deposition method using an atomic layer deposition method. As indicated by the white dotted lines in FIG. 3, the (001) planes are oriented in random directions, making it difficult to achieve complete alignment in a single direction, and thus it is difficult to sufficiently suppress delamination. Furthermore, when the load direction and sliding direction are not the same, frictional force is applied in the sliding direction, so even if delamination is suppressed in the load direction, delamination may occur in the sliding direction.

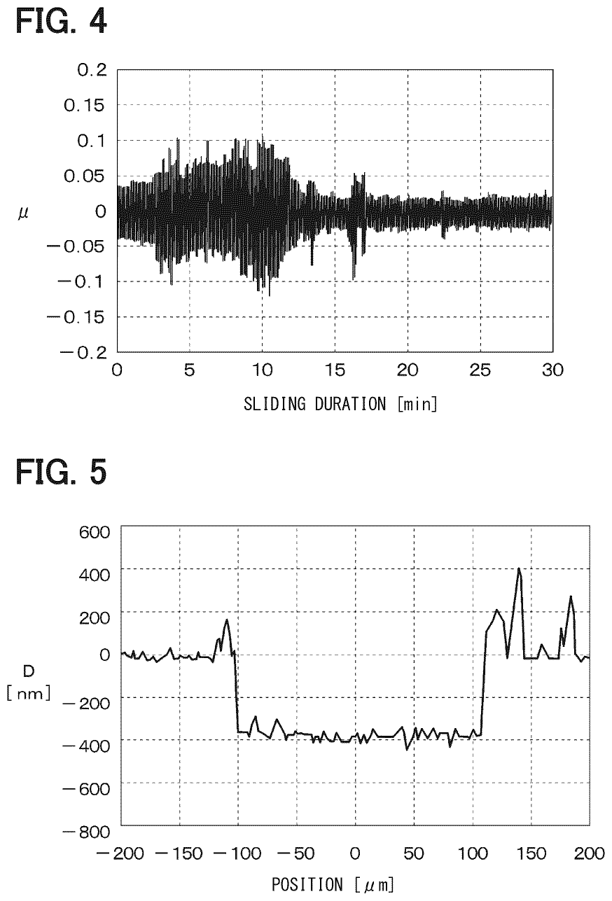

FIG. 4 shows the temporal change in sliding characteristics when conventional molybdenum disulfide films are formed on surfaces of both a ball and a disk, and the ball is reciprocated over a predetermined distance in a fixed reciprocating direction while being pressed against the disk. In FIG. 4, the vertical axis μ represents the coefficient of friction. FIG. 5 shows the cross-sectional profile of the disk in this case. In FIG. 5, the vertical axis D represents the wear depth. In the case of a comparative example using the conventional molybdenum disulfide films, the coefficient of friction was unstable as shown in FIG. 4, and significant wear occurred as shown in FIG. 5.

On the other hand, attempts have also been made to amorphize the molybdenum disulfide film by adding Ti. However, adding a Ti addition process to the manufacturing process leads to increased complexity of the production line and higher manufacturing costs, and achieving amorphization requires a large amount of Ti addition (for example, 20 atomic percent or more).

Here, as is well known, molybdenum disulfide has a layered structure formed by arranging S atoms regularly above and below Mo atoms so that the S/Mo atomic ratio is 2. In the crystal arrangement of the (001) planes viewed from the direction perpendicular to the layered direction, each Mo atom is adjacent to three S atoms. Therefore, by setting the S/Mo atomic ratio to 1.33 or less, one of the three S atoms adjacent to a Mo atom becomes deficient.

Accordingly, as a result of diligent research, the present inventors conceived of amorphizing molybdenum disulfide films by mixing carbon into the molybdenum disulfide to induce the aforementioned deficiency, disrupt periodicity, and inhibit the formation of the layered structure. Specifically, the present inventors found that the solid lubricant film 12 according to the present embodiment can be obtained by an atomic layer deposition method using an organic material having a tertiary-butyl group as the S source..

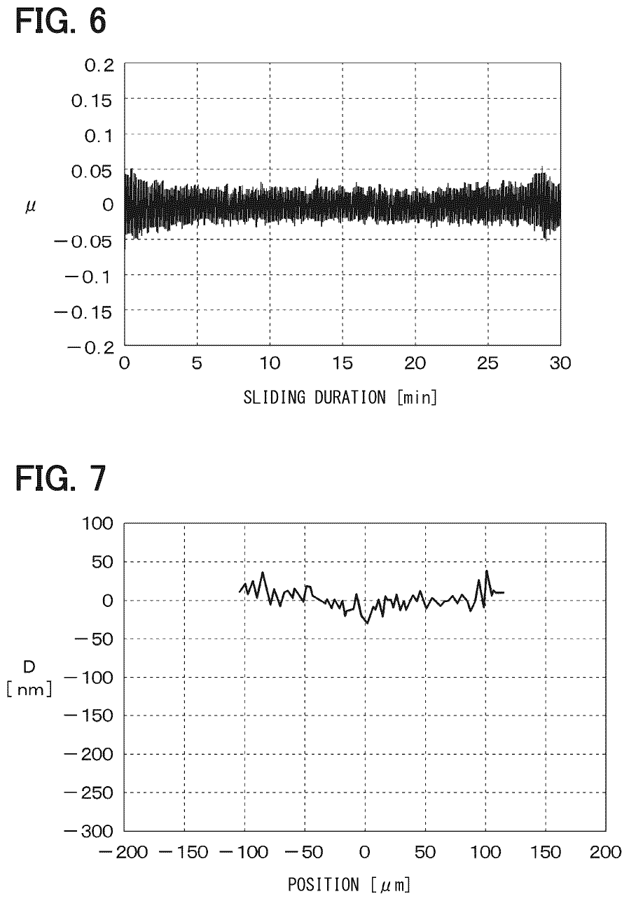

FIG. 6 shows the time-dependent change in sliding properties, and FIG. 7 shows the cross-sectional profile of the disk when a molybdenum disulfide film with a carbon content of 11 atomic percent is used in an example. In FIG. 6, the vertical axis μ represents the coefficient of friction. In FIG. 7, the vertical axis D represents the wear depth. As shown in FIG. 6 and FIG. 7, according to the example, the coefficient of friction stabilized at a low value, and the amount of wear was significantly suppressed.

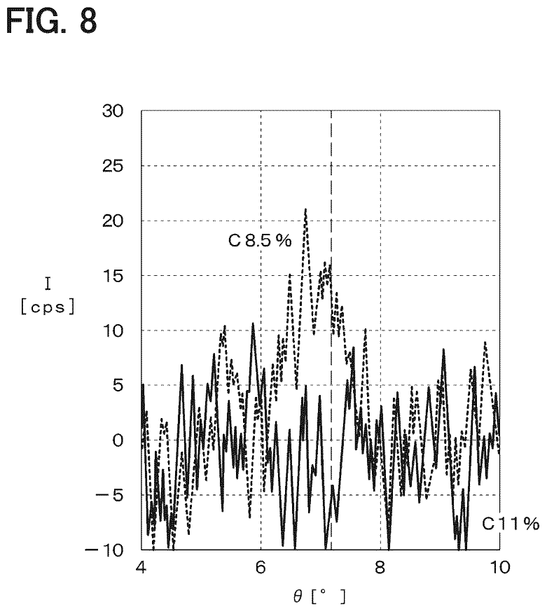

FIG. 8 shows the results of X-ray diffraction measurements using Cu Kα radiation for the example in which the carbon content in molybdenum disulfide is 11 atomic percent and for a comparative example in which the carbon content is 8.5 atomic percent. Atomic percent is also represented as at %. In FIG. 8, the vertical axis I represents the diffraction intensity, the horizontal axis θ represents the diffraction angle, and the vertical dashed line indicates the incident angle of 7.189° corresponding to a (002) plane.

As shown in FIG. 8, the comparative example clearly exhibits a reflection peak at 7.189°, whereas the example does not exhibit such a peak. It should be noted that “not exhibiting” a reflection peak at 7.189° includes “substantially not exhibiting” such a peak, that is, the presence of only a reflection peak at the background level.

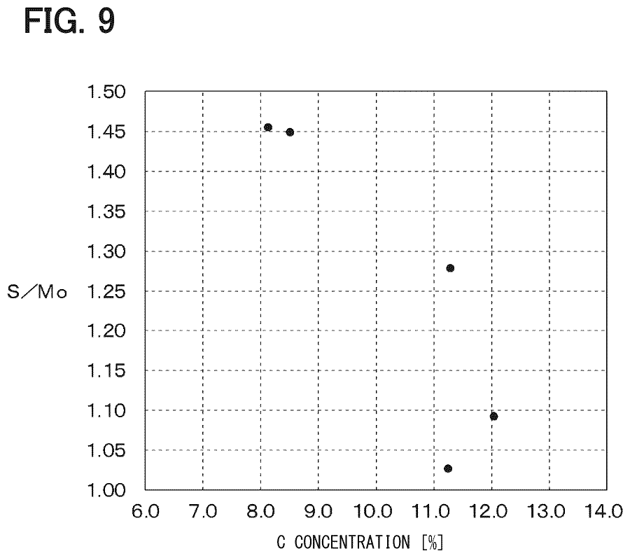

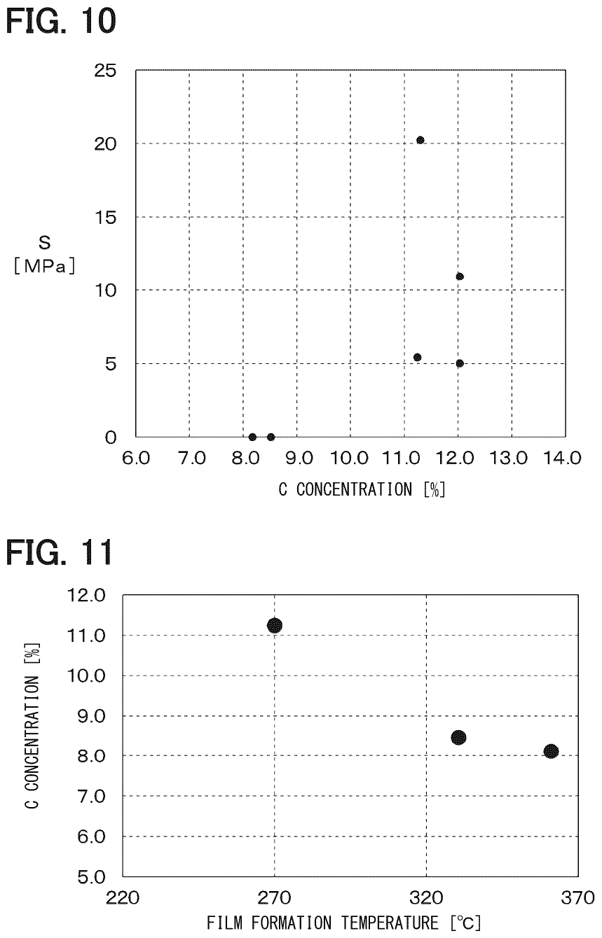

FIG. 9 shows the relationship between the carbon content and the S/Mo ratio. As is clear from the results of FIGS. 6 to 9, by setting the carbon content to 11 atomic percent or more, the S/Mo ratio can be made 1.33 or less, thereby enabling the molybdenum sulfide film to become amorphous. In addition, FIG. 10 shows the relationship between the adhesion strength and the carbon concentration in the solid lubricant film. In FIG. 10, the vertical axis S represents the adhesion strength. As shown in FIG. 10, by setting the carbon content to 11 atomic percent or more, the adhesion strength of the solid lubricant film 12 is greatly improved.

### Manufacturing Method

A manufacturing method of the sliding member 10 according to the present embodiment will be described in detail below. The sliding member 10 is obtained by forming the solid lubricant film 12 on the base member 11 by an atomic layer deposition method.

The atomic layer deposition method enables film formation by alternately supplying the precursors of each constituent element and allowing them to be adsorbed and to react on an atomic layer-by-layer basis. As the Mo precursor, for example, bis(tert-butylimido)bis(dimethylamino)molybdenum can be used. As the S precursor, for example, di-tert-butyl disulfide can be used.

A tertiary-butyl group has a structure in which three methyl groups branch out from a carbon atom. For this reason, steric hindrance that inhibits the adsorption of adjacent precursors tends to occur. Therefore, when adsorption occurs while the tertiary-butyl group remains, the approach of neighboring S atoms is inhibited, leading to a reduction in the S/Mo content ratio. Based on this, by forming the solid lubricant film 12 at a temperature below the decomposition temperature of the organic precursor material, favorable wear resistance as described above can be obtained.

FIG. 11 shows the relationship between the film formation temperature and the carbon content. As shown in FIG. 11, by setting the film formation temperature to 300° C. or lower, which is the decomposition temperature, the carbon content can be maintained at 11 atomic percent or higher.

Here, in the present embodiment, the solid lubricant film 12 is formed on the aluminum oxide coating film 112, which is provided on the coated surface 111 as the outermost surface of the base member 11. By forming the film on the aluminum oxide coating film 112, the reaction between iron and sulfur during film formation is effectively suppressed, making it possible to appropriately control the S/Mo content ratio.

### Modifications

The present disclosure is not necessarily limited to the above-described embodiment. It is possible to appropriate modify the above-described embodiment. Typical modifications will be described below. In the following description of modifications, differences from the above-described embodiments will be mainly described. In the following modifications, the same reference symbols as the above-described embodiment are used for the same or equivalent parts. Therefore, in the description of the following modifications, the descriptions given in the above-described embodiments regarding components having the same reference symbols may be appropriately incorporated unless there is a technical contradiction or a specific additional description.

There are no particular limitations on the shape or structure of the sliding member 10. For example, the base member 11 may be cylindrical or spherical. That is, the sliding surface 121 may be a curved surface.

The constituent elements of the above embodiment are not necessarily essential unless it is specifically stated that the constituent elements are essential in the above-described embodiment, or unless the constituent elements are obviously essential in principle. When numerical values such as the number, amount, and range of elements are mentioned, the present disclosure is not limited to the specific numerical values unless otherwise specified as essential or obviously limited to the specific numerical values in principle. Similarly, in the case where the shape, direction, positional relationship, or the like of the constituent elements is specified, the present disclosure is not necessarily limited to the shape, direction, positional relationship, or the like unless they are indicated as essential or are obviously essential in principle.

The modifications are not limited to the above-described examples. For example, multiple embodiments other than the above-described examples can be combined unless there is a technical contradiction. Similarly, multiple modifications may be combined with each other unless there is a technical contradiction.

What is claimed is:

1. A sliding member comprising:
a base member; and
a solid lubricant film disposed to cover the base member, wherein
the solid lubricant film is composed of molybdenum disulfide in which a sulfur-to-molybdenum content ratio is 1.33 or less.

2. The sliding member according to claim 1, wherein
the molybdenum disulfide constituting the solid lubricant film contains 11 atomic percent or more of carbon.

3. The sliding member according to claim 1, wherein
the solid lubricant film does not have a reflection peak at an incident angle of 7.189° in X-ray diffraction measurement using Cu Kα radiation.

4. The sliding member according to claim 1, wherein
the base member has an aluminum oxide coating film on an outermost surface of the base member, and
the solid lubricant film is disposed on the aluminum oxide coating film.

5. A manufacturing method of a sliding member that includes a base member and a solid lubricant film disposed to cover the base member and composed of molybdenum disulfide in which a sulfur-to-molybdenum content ratio is 1.33 or less, the manufacturing method comprising:
forming the solid lubricant film by an atomic layer deposition method using an organic material having a tertiary-butyl group as a sulfur-containing raw material.

6. The manufacturing method according to claim 5, wherein
the solid lubricant film is formed at a temperature equal to or lower than a decomposition temperature of the organic material.
